(19) United States
(12) Patent Application Publication
(10) Pub. No.: US 2014/0175892 A1
(43) Pub. Date: Jun. 26, 2014

(54) RESONATOR ENCLOSURE

(71) Applicant: WiTricity Corporation, Watertown, MA (US)

(72) Inventors: Jude R. Jonas, Hudson, NH (US); Matthew J. MacDonald, Boxford, MA (US); Morris P. Kesler, Bedford, MA (US); Andre B. Kurs, Chestnut Hill, MA (US); Jonathan Sirota, Sudbury, MA (US); Konrad J. Kulikowski, Denver, CO (US); Hamik Amirkhani, Watertown, MA (US)

(73) Assignee: WITRICITY CORPORATION, Watertown, MA (US)

(21) Appl. No.: 14/031,737

(22) Filed: Sep. 19, 2013

Related U.S. Application Data
(60) Provisional application No. 61/703,127, filed on Sep. 19, 2012.

(51) Int. Cl. H01F 27/02; H01F 38/14

(52) U.S. Cl. CPC H01F 27/02; H01F 38/14
USPC 307/104

(57) ABSTRACT

Described herein are improved configurations for a wireless power transfer and mechanical enclosures. The described structure holds and secures the components of a resonator while providing adequate structural integrity, thermal control, and protection against environmental elements. The coil enclosure structure comprises a flat, planar material with a recess for an electrical conductor wrapped around blocks of magnetic material as well as an additional planar material to act as a cover for the recess.

### CROSS-REFERENCE TO RELATED APPLICATIONS

This application claims the benefit of U.S. provisional patent application 61/703,127 filed Sep. 19, 2012.

### BACKGROUND

1. Field

This disclosure relates to wireless energy transfer, methods, systems and apparati to accomplish such transfer, and applications.

2. Description of the Related Art

Energy or power may be transferred wirelessly using a variety of techniques as detailed, for example, in commonly owned U.S. patent application Ser. No. 12/789,611 published on Sep. 23, 2010 as U.S. Pat. Pub. No. 2010/0237709 and entitled “RESONATOR ARRAYS FOR WIRELESS ENERGY TRANSFER,” U.S. patent application Ser. No. 12/722,050 published on Jul. 22, 2010 as U.S. Pat. Pub. No. 2010/0181843 and entitled “WIRELESS ENERGY TRANSFER FOR REFRIGERATOR APPLICATION,” U.S. Provisional Patent Application No. 61/530,495 filed on Sep. 2, 2011 and entitled “RESONATOR ENCLOSURE,” U.S. patent application Ser. No. 13/603,002 published on Mar. 7, 2013 as U.S. Pat. Pub. No. 2013/0057364 and entitled “RESONATOR ENCLOSURE,” U.S. patent application Ser. No. 12/770,137 published on Nov. 4, 2010 as U.S. Pat. Pub. No. 2010/0277121 and entitled “WIRELESS ENERGY TRANSFER BETWEEN A SOURCE AND A DEVICE,” U.S. patent application Ser. No. 12/899,281 published Mar. 31, 2011 as U.S. Pat. Pub. No. 2011/0074346 and entitled “VEHICLE CHARGER SAFETY SYSTEM AND METHOD,” U.S. patent application Ser. No. 13/536,435 published on Dec. 13, 2012 as U.S. Pat. Pub. No. 2012/0313742 and entitled “COMPACT RESONATORS FOR WIRELESS ENERGY TRANSFER IN VEHICLE,” U.S. patent application Ser. No. 13/608,956 published on Mar. 21, 2013 as U.S. Pat. Pub. No. 2013/0069441 and entitled “FOREIGN OBJECT DETECTION IN WIRELESS ENERGY TRANSFER SYSTEMS,” U.S. patent application Ser. No. 13/612,494 published Mar. 14, 2013 as U.S. Pat. Pub. No. 2013/0062966 and entitled “RECONFIGURABLE CONTROL ARCHITECTURES AND ALGORITHMS FOR ELECTRIC VEHICLE WIRELESS ENERGY TRANSFER SYSTEMS,” and U.S. patent application Ser. No. 13/275,127 published May 17, 2012 as U.S. Pat. Pub. No. 2012/0119569 and entitled “MULTI-RESONATOR WIRELESS ENERGY TRANSFER INSIDE VEHICLES,” the contents of which are incorporated in their entirety as if fully set forth herein.

One challenge in wireless energy transfer systems is robust and practical packaging or enclosures of resonators, coils, and other wireless energy transfer components. Proper packaging of resonators and coils is crucial for resonators and coils in vehicle and high power applications. Enclosures need to manage thermal loads and provide proper cooling for internal components, provide enough mechanical stability to prevent changes in parameters of coils, add minimal size to the overall size of the coil, provide weather resistance, and the like. Accomplishing all these requirements in a small package with minimal z-height of the enclosure is extremely challenging.

Therefore a need exists for methods and designs for coil and resonator enclosures with that add minimal size to the overall size while providing the necessary thermal, structural, and environmental capabilities.

### SUMMARY

Wireless energy transfer using non-radiative techniques may involve the use of magnetic resonator structures as the energy transfer elements. These resonator structures may be adapted to generate an oscillating magnetic field that may be used as the medium of wireless energy transfer. A magnetic resonator structure may comprise one or more inductive elements having an inductance and one or more capacitive elements having a capacitance. The size and shape of the resonator structures may be determined by the amount of power to be transferred and the application for which it is designed. A wireless energy transfer system may require the use of two or more magnetic resonators. In embodiments, magnetic resonator structures may be referred to as a source and/or device and/or repeater wherein a source resonator or resonators may couple with a device resonator or resonators to generally deliver power to a load. Successful wireless energy transfer may also require the use of electronics for the conversion of electrical energy, tuning between resonators, etc. Additionally, magnetic material may be used as a guide for the magnetic field, a shield from lossy materials, etc. In some embodiments, the one or more resonators may be wrapped around the magnetic material to optimize wireless energy transfer. Wireless energy transfer may be further optimized with the use of communication and control systems.

Resonator enclosures may need to hold some or all of the components needed for wireless energy transfer. An enclosure may be designed for optimal wireless energy transfer, mechanical stability, thermal management, aesthetics, or any combination thereof. In some embodiment, the energy and mechanical requirements of the application may be deciding factors in the design of the resonator enclosure.

### BRIEF DESCRIPTION OF FIGURES

FIG. 1A and FIG. 1B are isometric views of an enclosure structure.

FIG. 2 is an isometric view of an enclosure structure with magnetic material.

FIG. 3 is an isometric view of an enclosure structure with magnetic material and wrapped with wire.

FIG. 4A and FIG. 4B are cross section views of the enclosure structure with the wire, magnetic material, and optional cover.

FIG. 5 is an isometric view of a resonator enclosure.

FIG. 6A is an isometric view of a copper shield inside a resonator enclosure and FIG. 6B is a cross-sectional view of a representation of the resonator enclosure.

FIG. 7A is a cross-sectional view of a resonator enclosure with an encircled close-up view shown in FIG. 7B and FIG. 7C is an isometric view of a bar made of conductive material.

FIG. 8A and FIG. 8B are isometric and top views of the inside of a resonator enclosure showing a pattern of bars made of conductive material.

### DETAILED DESCRIPTION

As described above, this disclosure relates to wireless energy transfer using coupled electromagnetic resonators. However, such energy transfer is not restricted to electromagnetic resonators, and the wireless energy transfer systems described herein are more general and may be implemented using a wide variety of resonators and resonant objects.

In vehicle applications, resonator enclosures may be necessary for the success of wireless energy transfer as well as the protection of the enclosed components. Resonator enclosures may be designed for mechanical stability and thermal regulation of the components such as one or more resonators, electronics, magnetic materials, etc. These design considerations may be balanced by requirements of the enclosure to be a certain size, shape, or weight. Furthermore, the overall design of the wireless energy transfer system may determine the designs for the individual resonator enclosures, such as the one or more source and device enclosures.

Resonator Enclosure

Resonator and coil structures may require enclosures for deployment, safety, testing, transport, and the like. Resonator and coil enclosures may be useful for providing electrical safety, protection from the environmental elements, structural rigidity, thermal regulation, and the like.

Resonator enclosures for vehicles and other high power applications may be designed to support system operation at high power levels and strenuous environmental conditions that may affect the resonators and electronics. In vehicle applications, the resonator enclosures may be mounted on the outside or under a vehicle or placed on or under the ground. Device resonators mounted on the outside or underside of a vehicle may be exposed to environmental elements such as rain, snow, various temperatures, debris, and the like. Similarly, source resonators mounted in parking lots, structures, garages, and the like may be exposed to environmental elements such as rain, snow, various temperatures, debris, and the like.

In embodiments, a resonator enclosure may comprise sensors for safety, testing, thermal regulation, service, maintenance, control, and the like. Sensors may include as thermal sensors, field sensors, water sensors, acoustic sensors, gas sensors, infrared sensors, cameras, foreign object detection sensors, and the like. Sensors may be integrated into the internal area of an enclosure, embedded in the outer cover or shell of the enclosure, and/or may be located outside of the enclosure by extension, separation, etc. In some embodiments, a foreign object detection sensor or set of sensors may be integrated or otherwise attached to the other surface of the enclosure. A foreign object detection sensor may be designed to sense objects, extraneous objects, lossy objects, conductive objects, animals, humans, organic objects, or any other object that is near, on, by, beside, under, or over a resonator enclosure. In some embodiments, sensors may be utilized on both the source and device-side resonator enclosures in a wireless energy transfer system.

Physical Characteristics

In embodiments, the size, shape, and weight of the resonator enclosure may be critical for successful integration in applications. For vehicles, as for many other applications, overall size, and shape of the packaged coils and resonators used for wireless energy transfer may be an important factor since the packaged resonators need to fit in a predefined area and may not decrease a vehicle's ground clearance. The size, shape, and weight of the resonator enclosure may be determined by the amount of power required for the application. For example, in the vehicle application, the resonator in the enclosure may be larger for higher power requirements. In some embodiments, the magnetic material used may be scaled in length, width, and/or height in order to keep magnetic field losses at a minimum. For example, larger resonators for greater power or gap requirements may require larger pieces of magnetic material which in turn may require larger enclosures.

In some embodiments, the size of the resonator enclosure may be designed for safety purposes. The enclosure may be enlarged beyond the volume needed for the enclosed parts. In some cases, this size enclosure may serve as a visual reminder or warning to a user to keep away from an area where the magnetic field is at its strongest. For example, the enclosure that holds the resonator, electronics, magnetic materials, etc. may be located at the center of a larger enclosure which may provide the visual reminder to the user. The larger enclosure may be made of the same material as the smaller enclosure. In some cases, the larger enclosure may resemble a mat that may be easy for a vehicle or other machinery to drive over.

In some embodiments, a large enclosure may be advantageous for thermal management, mechanical stability, cost-effectiveness, and the like in areas where a small enclosure is not necessary. For example, for wireless energy transfer systems housed in large warehouses or parking lots for storing vehicles such as utility vehicles or construction machinery, a large enclosure may be used instead of a small enclosure.

The size, shape, and weight of the resonator enclosure may be determined by the gap required between the source and device of the wireless energy transfer system. For example, in the vehicle application, the resonator in the enclosure may be larger for gaps of greater distance. Conversely, the resonator in the enclosure may be smaller for gaps of lesser distance.

In some embodiments, the shape of an enclosure may also be an important factor for an application. For example, the shape of the enclosure may ensure that the package does not interfere with other parts of a vehicle. The shape of the enclosure may be determined by the placement of the enclosure on the vehicle. For example, the enclosure may be especially shaped to be located on the front, front underside, middle underside, back underside, back of the vehicle, etc. If the enclosure is to be located in a front bumper of a vehicle, it may be shaped to fit inside of a bumper. If the enclosure is to be located under a vehicle, it may need to be as thin as possible to not decrease the ground clearance. The shape of the enclosure may be determined by the shape of the resonator and/or internal placement of the electronics. For example, the electronics may be placed to one side of the resonator or otherwise partitioned from the resonator. In some embodiments, the type and model of a vehicle may determine the shape of an enclosure.

In some embodiments, the weight of an enclosed resonator may also be important. In the example of the vehicle, the weight of the enclosure may determine where and how the enclosure can be fixed on the underbody of the vehicle. The weight of the enclosure may also determine how and the type of material used to mount the device enclosure on to the vehicle. For example, the enclosure may be mounted onto the underside of a vehicle where it will have the most support and stability. This may include specific parts of the vehicle such as the frame of the vehicle which could provide a stable and strong location for the mounting of an enclosure. In some embodiments, the weight of the enclosure may be greater to provide more stability to the enclosed parts, including the resonator, electronics, magnetic material, shielding, etc. For example, elements of the enclosure may be potted or encased in resin to ensure both mechanical and electrical stability. This may create a heavier overall enclosure but with an advantage of having greater stability.

Enclosure Placement

In embodiments, the source resonators may be placed on the ground and may also be subjected to harsh environments as well as high weight loads such as vehicles driving over a source. In a source enclosure design, it may be preferable to reduce the height of the overall resonator structure such that it does not pose a tripping hazard, obstruction to machinery such as plows or lawn mowers, and the like. It may also be preferable to reduce the height of the overall resonator enclosure to ensure that a vehicle has enough ground clearance. For example, vehicles such as sports cars may have lower ground clearance and may require a source enclosure with a low profile so as to not significantly compromise the fidelity of the wireless power transfer.

In embodiments, source resonator structures may be buried or placed below ground level. Buried source resonators may be preferable in outdoor locations where the surface above the source resonator may need to be cleaned, plowed, mowed, treated, and the like. Buried source resonators may also be preferable for vehicles or machinery with low ground clearance. In embodiments, a cavity may be formed on top of the ground or below the ground to house the source resonator and to facilitate the removal and replacement of source coil/resonators. Source resonators may need to be replaced if they stop working, or if newer designs or system upgrades are desired or required.

In embodiments, source resonators may be placed below ground level, in dirt, asphalt, tar, cement, pavement, and the like, and combinations thereof, in a wireless power transfer system. In embodiments, it may be preferable to place the source resonators in specially designed cavities to facilitate repair, replacement, and/or maintenance of the resonators. In embodiments, a below ground, or partially below ground cavity may be formed in the dirt, asphalt, tar, cement, pavement, and the like, and the cavity may be designed to provide certain environments for the source resonator structure.

In some embodiments, a source resonator may be placed or integrated into a parking structure or lot, which may include the ground, walls, columns, sidings, poles, and the like. The size, shape, weight, and material of the enclosure of a source resonator may be designed such that it may successfully integrate into a parking structure. For example, the weight of the enclosure may be important if the enclosure is to be fixed on a wall or column some distance off of the ground.

In embodiments, the cavity may be formed in the ground itself and/or it may comprise an insert made of plastic, PVC, Delryn, ABS, Ultem, Teflon, Nylon blends, magnetic materials, conducting materials, non-lossy materials, or any materials described in this disclosure, depending on the overall system design.

In embodiments, an insert may be formed of a non-lossy material when the source resonator is embedded in non-lossy materials such as dirt. In embodiments, the purpose of the insert may be purely structural, and the insert may be used to keep the cavity from collapsing around the source resonator.

In embodiments, the insert may be formed of highly-conducting materials when the source resonator is to be embedded in a lossy environment, such as in cement surface comprising steel bars or rebar. In embodiments, the insert may provide shielding or field shaping functionality to the source resonator.

In embodiments, the insert may facilitate conditioning of the environment around the source resonator. For example, the insert may be designed to allow water to drain out of the cavity, or to allow nitrogen or other gases to be pumped into the cavity. In embodiments, the insert may be designed to allow probes or cameras to be inserted in the cavity to test the status of the source resonator and/or the cavity itself.

In embodiments, the insert may comprise sensors, such as thermal sensors, field sensors, water sensors, acoustic sensors, gas sensors, cameras, and the like, for use in diagnostic and maintenance activities. In embodiments, such sensors may be part of the system operation and be part of sensing and control systems that are used in the wireless power transfer system.

In embodiments, the cavity may be designed with a lid that may be removed to access the source resonator structure. In some embodiments, the lid may be designed so that it may be removed for maintenance and/or by maintenance professionals.

In embodiments, the cavity may be elongated to accommodate multiple resonators and/or repeater resonators. In embodiments, the cavity may run underneath driving surfaces and the source resonators may be configured to provide power to the device resonators and/or repeater resonators as they move over the sources in the cavities.

In embodiments, the cavity may serve as a temporary cover for a source enclosure. In some embodiments, a cover over the cavity may be automated or controlled via an external control. In such a case, a source enclosure may be exposed and ready for operation when the cover is removed. In a further embodiment, the level at which a source enclosure relative to the ground or device enclosure may be automated or controlled. For example, a user of the system may be able to control the opening and closing of a cover as well as the height at which the source rests before, during, and after wireless energy transfer may occur between the source and device.

Mechanical and Thermal Stability

In addition to these requirements, resonator enclosures may need to manage thermal loads and provide proper cooling for internal components and/or to properly cool the temperature on the surface of the enclosure. The enclosures may need to provide enough mechanical stability to prevent changes in the electrical parameters of resonators and to protect brittle magnetic material that may be part of some resonator structures. The enclosures may need to be mechanically stable with minimal or no use of structural metals, which may load and reduce the quality factor of the coil or resonator in the final assembly.

The inventors have designed an effective structure for holding and securing the components of a resonator while providing adequate structural integrity, thermal control, protection against environmental elements, and the like. The structure adds minimal size to the overall resonator assembly allowing the structure to be mounted on or under a vehicle and on or under the ground.

For further mechanical stability, the materials chosen for the enclosure may have trade-offs in its elasticity characteristics. In some embodiments, enclosure materials may be chosen to be more rigid than flexible to prevent damage to the enclosed parts, such as the electronics. In other embodiments, enclosure materials may be more flexible than rigid to prevent damage by absorbing impact. For example, to protect brittle yet heavy magnetic material used in a vehicle's device resonator enclosure, the enclosure material may need to be rigid enough to prevent bending, warping, or otherwise deforming. This may especially be important when the vehicle is in motion or exposed to harsh conditions.

In some embodiments, it may be necessary to mechanically isolate magnetic material in the enclosure. This may mean having to encase the magnetic material in supplemental materials and/or with supplemental methods. Methods may include fixing the magnetic material at its weakest areas or potting the magnetic material in resins such as polycarbonate or filled polymer. In some embodiments, it may be advantageous to use a thermally conductive plastic that does not have lossy electro-magnetic properties. For example, plastics filled with carbon or metals may induce losses in the electromagnetic field of the wireless power transfer system and these properties may be considered before using such materials in a resonator enclosure.

Example Embodiments

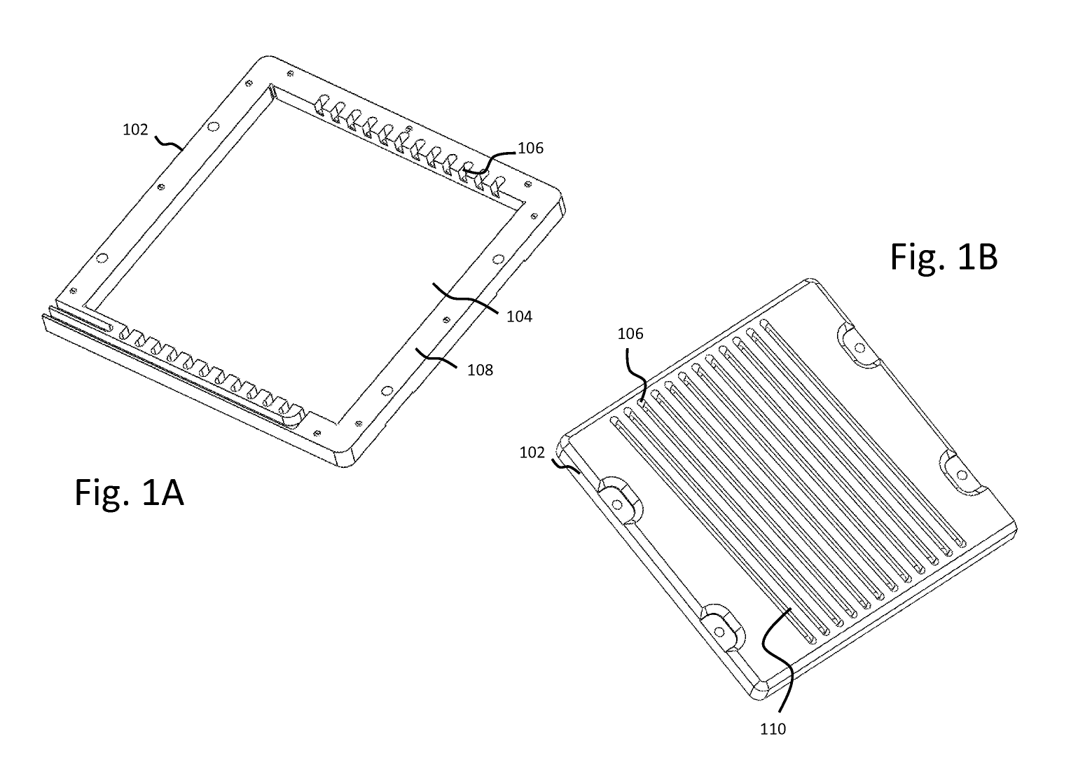

In an exemplary embodiment, a resonator enclosure structure comprises a flat, planar plate with a pocket for tiling blocks of magnetic material and a series of channels and holes for wrapping an electrical conductor around the blocks of magnetic material. The main features of the structure are described using an example embodiment. An example structure is shown in FIG. 1A and FIG. 1B. FIG. 1A shows the bottom side and FIG. 1B shows the top side of the enclosure structure. The main structure comprises a flat planar plate 102 with a recessed pocket 104 and a series of holes 106 and channels 110. The main structure may be machined, cast, injected molded, and the like out of, preferably, a non-lossy material such as plastic or a composite. Materials such as ABS, Nylon blends, Ultem, Delryn, and the like may be suitable. Those skilled in the art will appreciate that each material type has different mechanical and thermal properties which may make specific materials more suitable for different environments. The planar plate may comprise of a single solid piece of material or it may comprise two or more pieces that may be bonded, glued, screwed or attached together to form the overall structure.

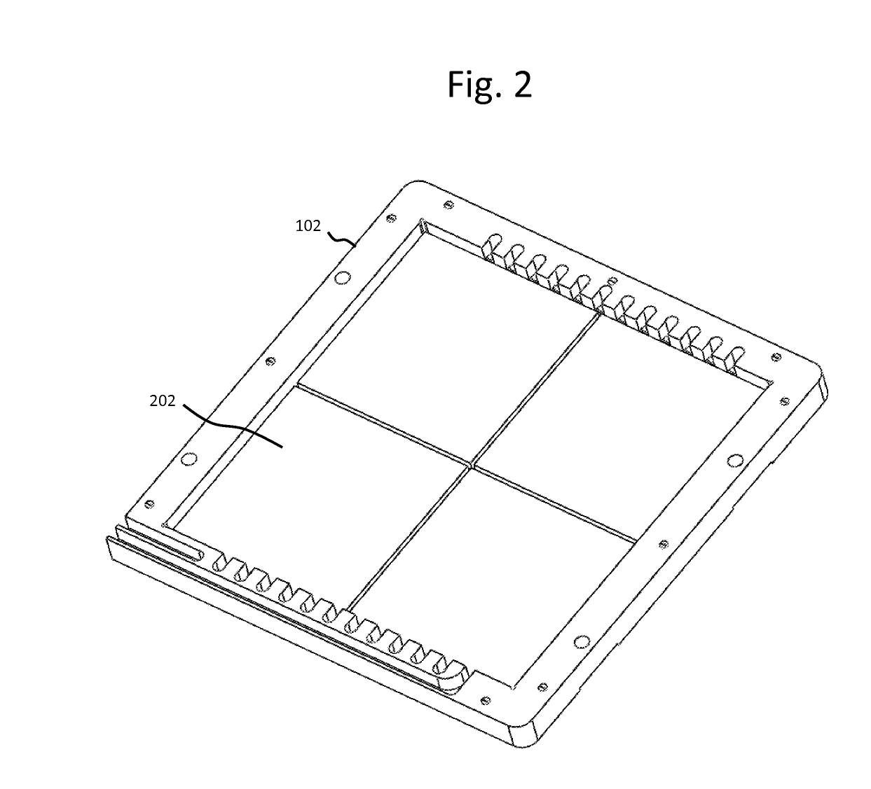

The recessed pocket 104 may be shaped and cut to a depth to house one or more blocks of magnetic material. FIG. 2 shows the structure 102 with four rectangular blocks of magnetic material 202. The pocket may be shaped to accommodate various dimensions and sizes of blocks. In the structure, the one or more blocks of magnetic material 202 may be assembles, placed, fitted, glued, potted, adhered, or attached together and/or to the structure 102 with other means.

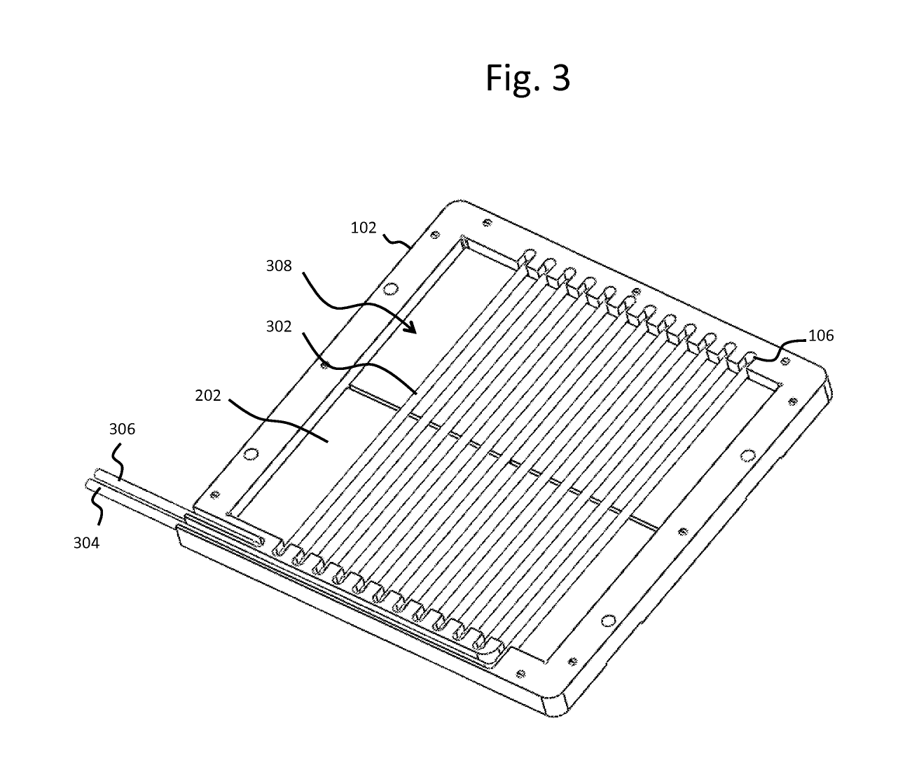

The series of holes 106 and channels 110 may be sized and shaped to house a conductor wire that wraps around the structure through the holes and around the blocks of magnetic material forming loops. An exemplary structure with a wrapped wire is shown in FIG. 3. The wire 302 wraps around the structure, passing through the holes 106 and fitting into the grooves on the top side (not shown) of the structure. The wire 302 wraps around the blocks of magnetic material 202 forming one or more loops. The ends of the wire 304, 306 may lead out of the structure and connect to other electronics or components. In embodiments a layer of electrical insulator may be placed between the wire and the blocks of magnetic material. In other embodiments, some electronic components or other components may also be housed in the recessed pocket of the structure.

The pocket area of the structure 308 that houses the blocks of magnetic material 202 and the wire 302, and optionally other components, may be potted and/or filled with epoxy to stabilize the components, may provide a good thermal pathway to the top of the structure and/or may provide structural stability in case of vertical loads.

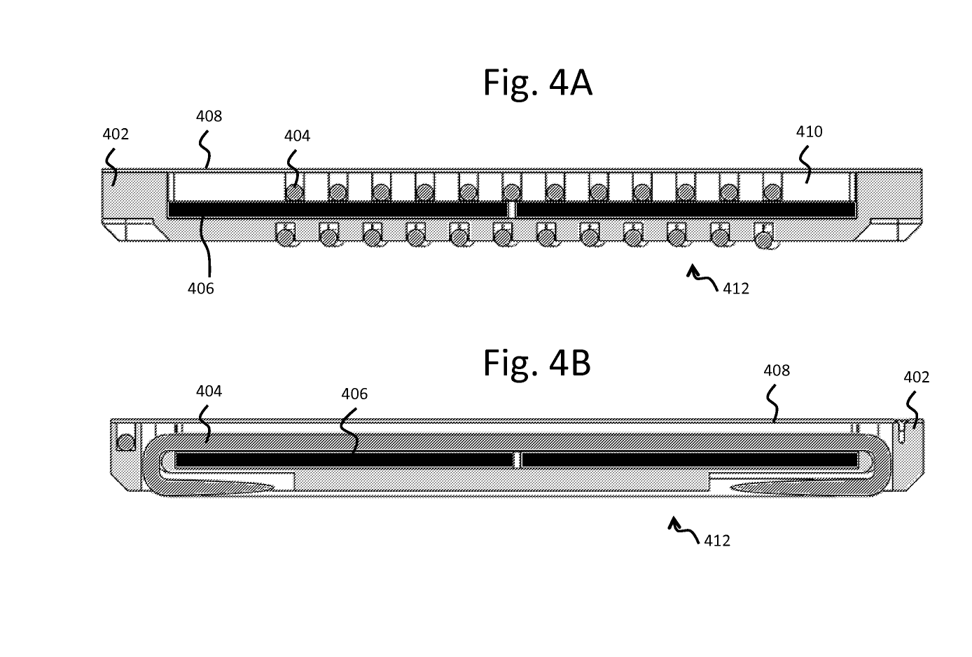

A cross sectional view of the structure with the wire and magnetic material is shown in FIG. 4A. The figure shows a cross section of the structure that is parallel to the axis of the loops formed by the wire when wrapped around the structure. The cross section shows the structure 402 with the magnetic material 406 inside the pocket area 410 of the structure and the cross section of the wire 404 that wraps around the structure and the magnetic material.

Another cross sectional view of the structure that is perpendicular to the axis of the loops formed by the wire is shown in FIG. 4B. The cross section shows the structure 402 with the magnetic material 406 and the wire 404 that wraps around the structure and the magnetic material.

FIGS. 4A and 4B show an optional cover 408 on the bottom side of the structure. The cover may comprise a good electrical conductor such as copper or aluminum. In an embodiment, the conductor may provide some shielding and some heat transfer functionality. The cover may also preferably comprise a good thermal conductor and may be glued or thermally connected to the potting or epoxy that fills the pocket 410 of the structure to provide a good thermal path. In applications the cover 408 may be attached to a larger thermal mass or a heat sick to dissipate the heat away from the internal components of the structure. In embodiments, the cover may make good thermal contact with a vehicle. For example, thermal grease, tape, foam, and the like may be used between the cover and the attachment surface of the vehicle. In some embodiments, external cooling by fans, cooling pipes, thermal electric coolers (TECs), heat sink fins, and the like may be used to cool the cover of the resonator structure.

In embodiments an optional cover (not shown) may also be positioned on the top side of the structure 412 to cover the wires and provide for an additional protection against impact from debris. Optionally the channels on the top side of the structure that house the wires may also be potted or epoxied completely hiding and encapsulating the wire inside the structure.

In embodiments the structure may include an additional pocket or section for additional electronics or electrical components such as capacitor, inductors, and the like. The electronic components may be thermally in contact with the outer enclosure cover as a path for heat to escape. In some embodiments, electronic components may be positioned or protected based on their type. For example, a thermal interface material may be used between the top of a capacitor or group of capacitors and the conductive material to provide a heat sink.

In an exemplary embodiment, a 25 cm by 25 cm with a 2 cm height structure was sufficient to enclose a 20 cm by 20 cm coil structure capable of receiving 3.3 kW of power in a wireless power transfer system. The structure was able to dissipate more than 75 Watts of power during operation with a 30° C. temperature rise. The total weight of the structure with wire and magnetic material was about 3 kg. The structure material was Ultem. The size of the structure may be scaled or enlarged to dissipate more heat and reduce the temperature rise of the resonator structure when the system is operating. The dimensions and material selection may be adapted to better match the required properties for larger or smaller dimensioned structures. The dimensions and material selection may also be adapted for wireless energy systems of varying power levels, such as greater than 1 W, greater than 3 W, or greater than 6 W.

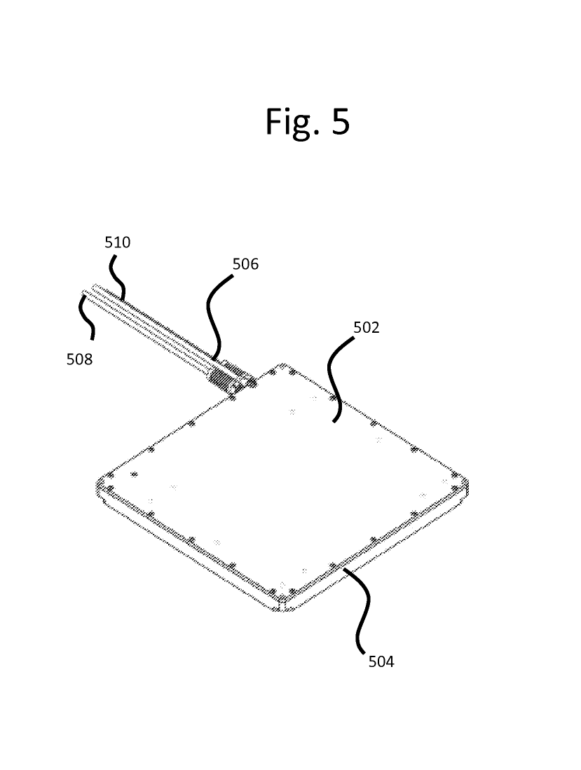

In another exemplary embodiment, a 30 cm by 25 cm by 2 cm is sufficient to enclose a coil structure capable of receiving 3.3 kW of power in a wireless power transfer system. FIG. 5 shows an embodiment of the outer mechanical enclosure for a resonator in a wireless energy transfer system. The top of the enclosure 502 may be made of aluminum or another good conductor that will aid in dispersing heat from the internal parts of the enclosure. The top of the enclosure may be grounded via a ground wire 506. The bottom of the enclosure 504 may be made of a plastic such as Ultem that may be primarily chosen to ensure rigidity in the structure. Plastics may also ensure that the overall structure is lightweight if installed on a vehicle, on a wall, column, or anywhere that requires mounting away from the ground. Leading into the outer enclosure are two cables or wires 508, 510 for the input and output from the resonator enclosure. In some embodiments, there may be one or multiple cables to provide the input and/or output leading from the enclosure.

The outer structure parts may be sealed with a gasket. A gasket may be made of thermoplastic elastomer, rubber, or other non-lossy material that can withstand high temperatures. A shield between the resonator and electronics may be used. In embodiments, the shield may be made of a material that has good electrical and thermal conductivity, such as copper. In some embodiments, a copper shield may be in thermal contact with the electronics and an exemplary aluminum cover. A copper shield may provide a heat path from the electronics to a cover and may also be used as a heat sink of the resonator. In embodiments, the copper shield may be a continuous piece of copper, soldered together from smaller pieces of copper, and the like. A magnetic material may be used as a shield between the resonator and the metallic underbody of the vehicle. The magnetic material may prevent losses due to the metallic parts and may also be used to guide the magnetic field of the resonator.

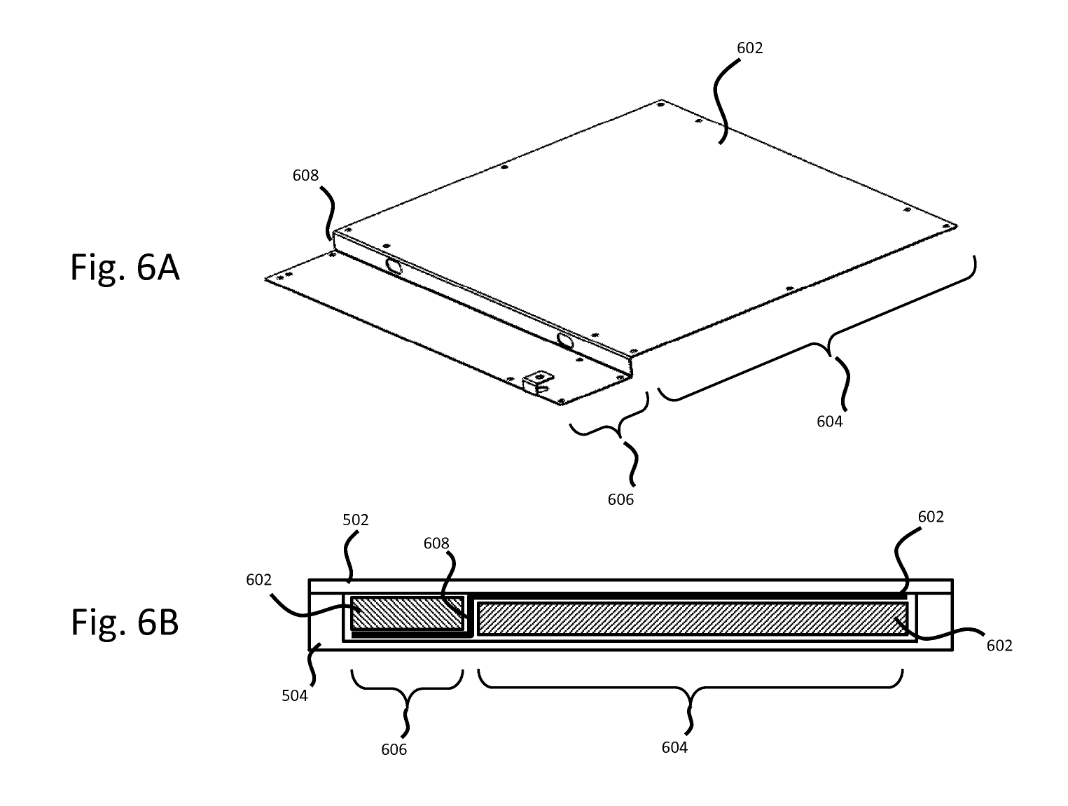

In some embodiments, a copper plate may be used to shield the electronics from the resonator in the enclosure. A copper shield is shown in one exemplary embodiment in FIG. 6A. The copper shield 602 is shaped to accommodate the difference in volume of the area that holds the electronics 606 and the area that holds the resonator 604. The continuous piece of copper shield is stepped to create a barrier 608 between the electronics and resonator. A copper shield may also be used for thermal management. In some embodiments, a copper shield may be used to create a path for the heat from the electronics and/or the resonator to dissipate to the outer surface of the enclosure. Additional materials may be used with copper to create a path for heat to escape, such as thermal interface material (TIM). TIM may be used to ensure a good thermally conductive connection between the copper shield and the outer cover of the resonator enclosure. Some parts of the enclosure may need to be insulated from the copper shield. In such a case, a thermal insulator such as a plastic may be used to create this barrier.

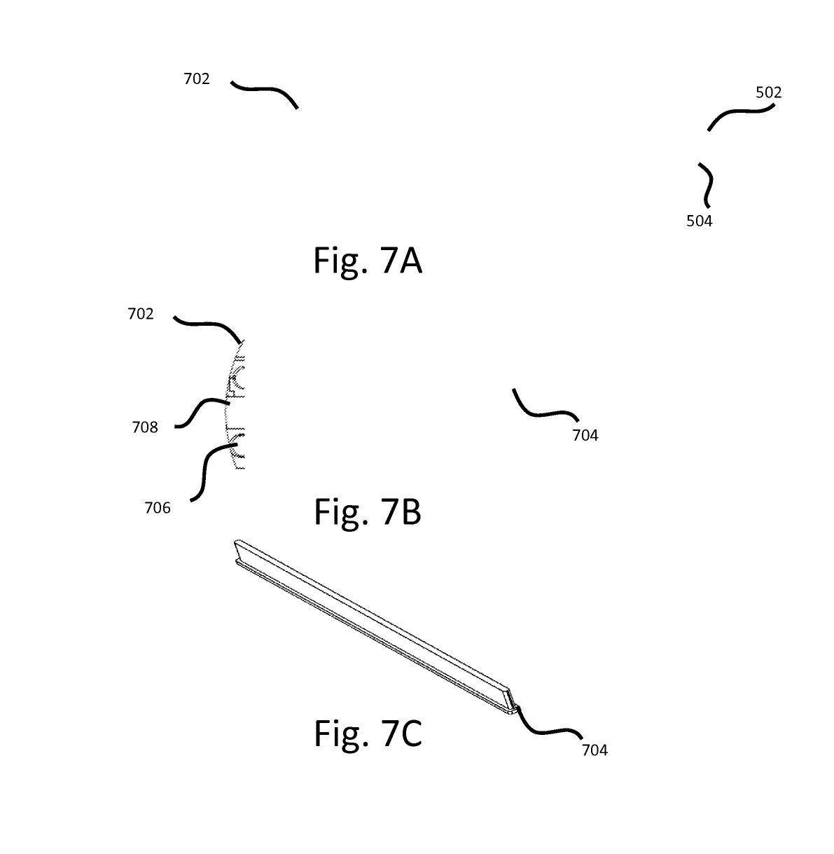

In some embodiments, other materials may be used to provide a path for heat to escape to the outer surface of the resonator enclosure. For example, heat may build up in the magnetic material that forms the core of the resonator coil. As heat builds up in the magnetic material, it may not be able to dissipate heat efficiently. The inventors have designed an enclosure part such that more paths are created to dissipate heat. FIG. 7 shows an exemplary embodiment of the invention. FIG. 7A and sub-view FIG. 7B show a cross section 702 of a resonator enclosure, which has an outer cover of aluminum 502 and Ultem 504. To create the path for heat to dissipate from the magnetic material to outer cover, T-shaped bars of conductive material, such as aluminum, are placed between the magnetic material 708 and the outer cover (also made of aluminum) 502. Furthermore, the bars of aluminum 704 are designed and shaped such that they do not come in contact with the conducting loops of the resonator coils 706. This allows only the heat from the magnetic material to be transferred to the bars of aluminum which is then transferred to the outer cover of the resonator enclosure.

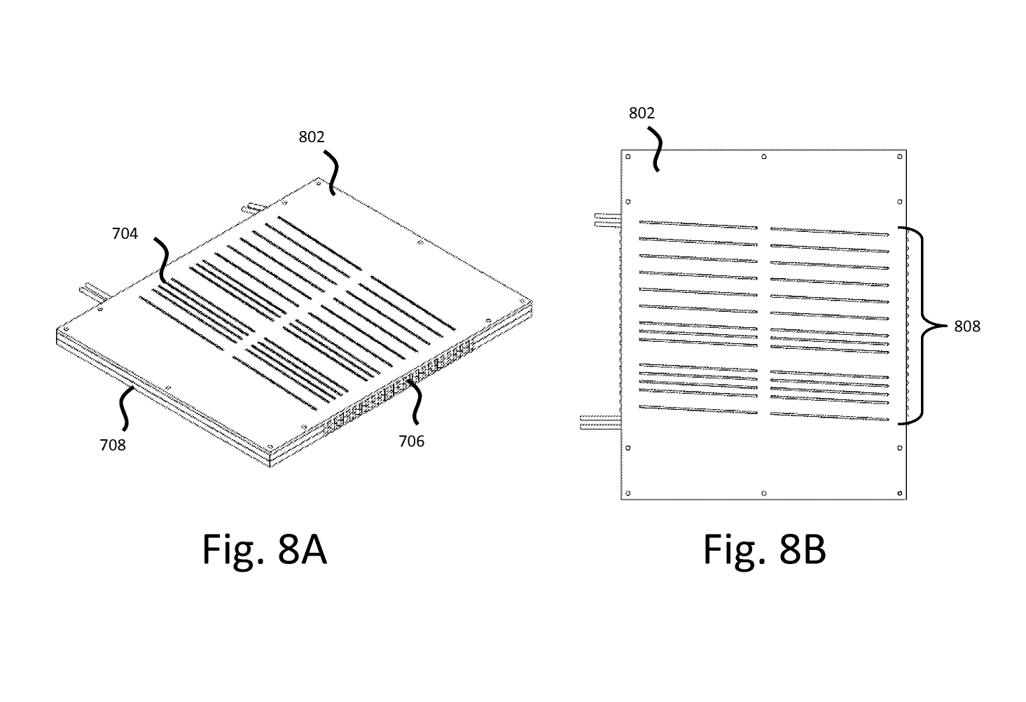

In a further embodiment, the bars of conductive material may be placed in an optimal pattern for efficient heat transfer from the magnetic material to the outer surface of the resonator enclosure with minimal impact on the electromagnetic properties of the resonator itself. FIG. 8 shows an exemplary embodiment of such a pattern. FIG. 8A shows an internal view of an exemplary resonator enclosure where a resonator conductor 706 is wrapped around magnetic material 708. A top view 802 is provided in FIGS. 8A and 8B to show the pattern of the bars 704. The pattern 808 illustrates that the areas where the bars may be needed the most may not be linear with respect to the resonator or to the magnetic material. The pattern may be optimized empirically or through experimentation with a resonator design and/or resonator enclosure design.

While the invention has been described in connection with certain preferred embodiments, other embodiments will be understood by one of ordinary skill in the art and are intended to fall within the scope of this disclosure, which is to be interpreted in the broadest sense allowable by law.

All documents referenced herein are hereby incorporated by reference in their entirety as if fully set forth herein.

We claim:

1. A resonator enclosure for wireless energy transfer comprising:
a first generally rectangular planar material having a top and a bottom side wherein a recess is fabricated into the top side;
a first section of the recess containing a magnetic resonator comprising a conductor having one or more turns and wrapped around one or more pieces of magnetic material;
a second section of the recess containing electronic components;
a sheet of conductive material forming a barrier between the first section of the recess containing a magnetic resonator and the second section of the recess containing electronic components; and
a second generally rectangular planar material forming a cover to the recess fabricated into the first generally rectangular planar material.

2. The enclosure of claim 1, wherein the first generally rectangular planar material is made of a non-lossy material.

3. The enclosure of claim 1, wherein the first section of the recess comprises a plurality of parallel grooves to hold the conductor wrapped around the rectangular form of magnetic material.

4. The enclosure of claim 1, wherein the sheet of conductive material is copper.

5. The enclosure of claim 1, wherein the sheet of conductive material is in thermal contact with the electronic components and thermally isolated from the magnetic resonator.

6. The enclosure of claim 1, wherein the sheet of conductive material is in electrical contact with the electronic components and electrically isolated from the magnetic resonator.

7. The enclosure of claim 1, wherein the second generally rectangular planar material is made of a conductive material.

8. The enclosure of claim 7, wherein the second generally rectangular planar material is aluminum.

9. The enclosure of claim 1, wherein the sheet of conductive material is in thermal contact with the second generally rectangular planar material.

10. The enclosure of claim 9, wherein the sheet of conductive material is in thermal contact with the second generally rectangular planar material via a thermal interface material.

11. The enclosure of claim 1, further comprising conductive material placed in thermal contact between the magnetic material and the sheet of conductive material forming a barrier between the first section of the recess containing a magnetic resonator and the second section of the recess containing electronic components.

12. The enclosure of claim 11, wherein the conductive material is placed in between the one or more turns of the conductor wrapped around the one or more pieces of magnetic material without coming in thermal contact with the one or more turns of the conductor wrapped around the one or more pieces of magnetic material.

13. The enclosure of claim 11, wherein the conductive material is placed to provide an efficient path for heat to travel from the one or more pieces of magnetic material to the second generally rectangular planar material.

14. The enclosure of claim 1, wherein the second generally rectangular planar material forming a cover can be separated from the first generally rectangular planar material for service.

15. The enclosure of claim 1, wherein the first and second generally rectangular planar materials are joined via a gasket made of non-lossy material.
